(19) United States
(12) Patent Application Publication
(10) Pub. No.: US 2007/0100774 A1
(43) Pub. Date: May 3, 2007

(54) Method of providing identity theft protection

(75) Inventor: Jerry Lewis Abdon, Altoona, FL (US)

Correspondence Address: ROBERT L. ABDON, 21019 FLAMING ARROW TRAIL, CROSBY, TX, 77532, US

(73) Assignee: JERRY LEWIS ABDON, ALTOONA, FL (US)

(21) Appl. No.: 11/545,843

(22) Filed: Oct. 11, 2006

Related U.S. Application Data
(60) Provisional application No. 60/727,121, filed on Oct. 14, 2005.
(60) Provisional application No. 60/727,102, filed on Oct. 14, 2005.

(51) Int. Cl. G06Q 99/00; H04L 9/00; H04K 1/00

(52) U.S. Cl. 705/80

(57) ABSTRACT

Methods of providing identity theft protection is disclosed. The method includes providing a contract of insurance is made in which the rights and duties of an insurer and an insured relating to the legal services are set out; and coupling the contract to a sale of goods, services, or real property. Some methods include selling goods, services, or real property wherein a first party provides the goods, services, or real property; and a second party provides a contract of insurance for legal representation, wherein the rights and duties of an insurer and an insured relating to the legal services are set out in the contract, and wherein the legal services include services related to resolving the unauthorized use by a third party of the insured's financial or personal information, wherein the third party attempts to use or uses the information to commit fraud or impersonate the insured.

### PRIOR RELATED APPLICATIONS

This application claims priority to prior filed U.S. Provisional Patent Application Ser. No. 60/727,102, filed on Oct. 14, 2005, incorporated by reference herein in its entirety.

### FEDERALLY SPONSORED RESEARCH STATEMENT

Not applicable.

### REFERENCE TO MICROFICHE APPENDIX

Not applicable.

### TECHNICAL FIELD

Embodiments of the invention provide methods for providing identity theft protection services. In particular embodiments, the method relates to providing an insurance-type product that includes provision of legal services to an insured party and coupling the legal services with the sale of goods, services, or real property.

### BACKGROUND OF THE INVENTION

Over the span of a few short years the Internet has gone from a highly specialized quasi-public computer network used by a relatively narrow group of individuals and institutions, to a broadly based worldwide web that touches upon the daily lives of hundreds of millions, if not billions, of individuals, businesses and other entities across the globe. The explosive growth of the Internet has brought with it an equally expansive growth of its use for exchanging and sharing information, providing services and conducting commercial or business transactions. Business transactions conducted over the Internet provides individuals across the world with the ability to shop for a wide variety of goods and services, offered by countless different businesses and commercial operations, merely through the use of a personal computer connected to the Internet by way of a standard modem. Many have predicted that in the foreseeable future the volume and dollar value of merchandise purchased through e-commerce will rival or exceed what is purchased through more traditional methods.

Unfortunately, with the rapid advancement of the Internet and its use by more and more individuals, businesses and other entities there has also been a significant increase in the incidence of invasion of privacy, identity theft, fraud and financial theft by unscrupulous individuals. Since by the very nature of e-commerce transactions the parties, or the buyer and seller, rarely meet face to face, much of the merchandise purchased over the Internet is paid for by consumers through the use of credit cards or debit cards. Typically a consumer places an order for merchandise over the Internet and provides the merchant with details concerning his or her credit card (or in some cases debit card) so that the merchant may process payment for the goods prior to their shipment. Companies that engage in electronic commerce often incorporate elaborate security, firewall and encryption systems in order to help safeguard sensitive or confidential financial information sent and received over the Internet. But even with such safeguards in place, confidential financial or other information is often vulnerable to access by unauthorized parties who are able to break through security barriers, firewalls or encryption systems. As a result, the security of credit, financial and other sensitive or confidential information that may be provided over the Internet, and its potential theft or fraudulent use, is a growing concern to consumers, merchants and financial institutions alike. Aside from elaborate security and encryption systems, in most cases the only alternative available to a consumer and a merchant that provides for the security of the consumer's credit information is for the consumer to forward payment by means of a check or money order directly to the merchant. However, that alternative is often either undesirable or impractical, due to the administrative inconvenience and delay associated with having to forward payment through other channels for manual processing prior to shipment of the goods or merchandise.

A recent survey 4,057 randomly selected adults suggests that over a 5 year period 27.3 million people were victimized when someone made unauthorized charges on their credit cards, took money from their bank accounts, or obtained a credit card or official document in their name. In 2002, the FTC alone received 161,819 complaints about identity theft. In that same year it was reported that 9.9 million Americans had been victims of identity theft, costing them $5 billion and businesses and financial institutions $48 billion. It has been reported that identity thieves have even secured financing by giving security interests in goods and property owned by the victim, thereby subjecting the victim the possibility of losing their home when the thief does not pay.

Even in the face of such devastating consequences, most people do not have protection from the damage of identity theft. Thus, a method of providing identity theft protection would be useful to a large number of people.

### DETAILED DESCRIPTION OF EMBODIMENTS OF THE INVENTION

Methods of providing legal services are disclosed. Methods include providing a contract of insurance wherein the rights and duties of an insurer and an insured relating to the legal services are set out; and coupling the contract to a sale of goods, services, or real property. Thus, when a person purchases the good, service or real property, they also receive an insurance policy relating to the provision of legal representation. In particular methods, the sale or offer to sell goods, services or real property includes coupling the sale or offer to sell the goods, services, or real property to with a contract of insurance for legal representation.

In some of the methods described above, the contract provides for protection or legal representation for identity theft claims. Some methods further including providing a credit watch service to monitor the credit rating of the insured. The credit watch service may notify the insured or the insurer of credit-related inquiries. Thus, a credit watch service may alert the insured of credit-related transactions thereby warning the insured of a potential identity theft where the insured did not authorized the transaction. Where the insured did not authorize the transaction and suffers a monetary or credit rating loss, the insured may employ the legal services provided for in the contract that is coupled with the purchase. The legal services need not relate in any manner to the purchase, but rather relate to other purchases that where not authorized by the insured.

While the contract for legal services may be coupled to any good, service, or real property, in some embodiments the goods are a vehicle. Particular types of vehicles, include but are not limited to passenger cars, commercial trucking vehicles, motorcycles, bicycles, and watercrafts.

When real property is involved, the real property may be improved or unimproved.

Methods described herein envision all manner of legal services. For instances, some methods include negotiating, mediating, settling, or litigating a dispute between the insured and at least one third party. Particularly, the legal services would include any services typically required for settling an identity theft dispute.

Particular embodiments of the invention are directed to selling a car wherein the method includes offering a contract of insurance for legal representation, wherein the rights and duties of an insurer and an insured relating to the legal services are set out; and wherein the contract provides for legal representation of the insured related to resolving the unauthorized use by a third party of the insured's financial or personal information, wherein the third party attempts to use or uses the information to commit fraud or impersonate the insured.

Other methods are directed to selling goods, services, or real property, comprising a first party that provides or has the ability to sell the goods, services, or real property; and a second party provides a contract of insurance for legal representation, wherein the rights and duties of an insurer and an insured relating to the legal services are set out in the contract, and wherein the legal services include services related to resolving the unauthorized use by a third party of the insured's financial or personal information, wherein the third party attempts to use or uses the information to commit fraud or impersonate the insured.

What is claimed is:

1. A method of providing legal services, comprising:
(a) providing a contract of insurance is made in which the rights and duties of an insurer and an insured relating to the legal services are set out; and
(b) coupling the contract to a sale of goods, services, or real property.

2. The method of claim 1 wherein the contract provides for protection for identity theft claims.

3. The method of claim 1 further including providing a credit watch service to monitor the credit rating of the insured.

4. The method of claim 3 wherein providing the credit watch service includes notifying the insured or the insurer of credit-related inquiries.

5. The method of claim 2 wherein the goods include a vehicle selected from the group consisting of a passenger car, a commercial trucking vehicle, a motorcycle, a bicycle and a watercraft.

6. The method of claim 2 wherein the real property is improved or unimproved.

7. The method of claim 1 wherein the legal services include all manner of legal representation including, negotiating, mediating, settling, or litigating a dispute between the insured and at least one third party.

8. A method of selling or goods services or real property, comprising:
coupling the sale of the goods, services, or real property to with a contract of insurance for legal representation related to unauthorized transactions performed by a third party.

9. The method of claim 8 wherein the contract provides for protection for identity theft claims.

10. The method of claim 8 further including providing a credit watch service to monitor the credit rating of the insured.

11. The method of claim 10 wherein providing the credit watch service includes notifying the insured or the insurer of credit-related inquiries.

12. The method of claim 9 wherein the goods include a vehicle selected from the group consisting of a passenger car, a commercial trucking vehicle, a motorcycle, a bicycle and a watercraft.

13. The method of claim 9 wherein the real property is improved or unimproved.

14. The method of claim 8 wherein the legal representation includes all manner of legal representation including, negotiating, mediating, settling, or litigating a dispute between the insured and at least one third party.

15. A method of selling goods, services, or real property, comprising:
(a) a first party that provides or has the ability to sell the goods, services, or real property; and
(b) a second party provides a contract of insurance for legal representation, wherein the rights and duties of an insurer and an insured relating to the legal services are set out in the contract, and wherein the legal services include services related to resolving the unauthorized use by a third party of the insured's financial or personal information, wherein the third party attempts to use or uses the information to commit fraud or impersonate the insured.
